(19) United States
(12) Patent Application Publication
(10) Pub. No.: US 2026/0356120 A1
(43) Pub. Date: Nov. 12, 2026

(54) A DECORATIVE PANEL COMPRISING TWO DECORATIVE FOILS

(71) Applicant: UNILIN, BV, Wielsbeke (BE)

(72) Inventor: Benjamin CLEMENT, Waregem (BE)

(73) Assignee: UNILIN, BV, Wielsbeke (BE)

(21) Appl. No.: 19/141,275

(22) PCT Filed: Dec. 13, 2023
(86) PCT No.: PCT/IB2023/062591

§ 371 Date: Jun. 19, 2025

(30) Foreign Application Priority Data
Dec. 19, 2022 (EP) 22214623.5

(51) Int. Cl. B44C 5/04; E04F 15/10

(52) U.S. Cl. CPC B44C 5/0476; E04F 15/107

(57) ABSTRACT

A decorative panel may include a substrate and a top layer. The top layer may include a decorative pattern. The top layer may include a first decorative foil having a substantially uniform color and a second decorative foil having a printed décor. The second decorative foil may overlay the first decorative foil to form the decorative pattern.

This application claims priority under 35 USC § 119(a)-(d) from EP patent application number 22214623.5, which was filed on Dec. 19, 2022, the entire content of which is incorporated herein by reference.

### BACKGROUND

### 1. Field

The present invention relates to a decorative panel of the type comprising a substrate and a top layer having a printed pattern, for example floor panels, wall panels, ceiling panels, or furniture panels. The invention further relates to a method for manufacturing a decorative panel and to a decorative foil to be used in a decorative panel.

### 2. Related Art

Decorative panels comprise a top layer that usually comprise a decorative foil having a pattern printed on top and optionally a wear layer that can comprise hard particles to protect the decorative layer from wear and scratches. The top layer can be fixed on a substrate either using a glue or using heat and pressure.

In particular, the decorative layer and the optional wear layer can comprise foil that can be made of paper or of a thermoplastic material, like for example PVC. In case said foil is made of paper it needs to be impregnated with an aminoplast resin like, melamine formaldehyde, in order to be thermally fixed on the substrate.

In the current practice, the foil forming the decorative layer shows a white color in order to provide a good background and opacity for the decorative pattern which is printed there upon. The decorative pattern can be printed using rotogravure printing, which guarantees high production rate and low cost on large production batches of a single decor, or digital inkjet printing, which guarantees a wide flexibility and variety of décor for each production batch. In case of digital printing the foil may need to be coated with a inkjet receiver coating which prevents inks from bleeding and ensures high resolution of the decorative pattern. In case the decorative layer comprises a thermoplastic foil decorated with inkjet printing, it may be necessary to add an adhesion promoter coating on the decorative pattern, or add an adhesion promoter agent in the primer and/or in the ink, to ensure a good adhesion with the thermoplastic foil of the wear layer. Said adhesion promoter coating, and/or the primer itself, my be very expensive.

The decorative panels, once manufactured or during manufacturing, may need to be machined, for example for squaring, for cutting to form multiple panels from a starting larger board or for milling a locking profile on an edge of the panel. This machining operation can damage the decorative layer thereby revealing the white color of the foil supporting the decorative pattern.

### SUMMARY

The present invention aims in the first place to provide an alternative decorative panel which, in accordance with several of its preferred embodiments, is directed to solve one or more of the problems arising in the state of the art.

Thereto, the present invention, according to its first independent aspect, relates to a decorative panel of the type comprising a substrate and a top layer, wherein the top layer comprises a decorative pattern, wherein the top layer comprises a first decorative layer, preferably having a substantially uniform color, and a second decorative layer comprising a printed décor, wherein the second decorative layer overlays the first decorative layer so to form the decorative pattern. Thanks to the invention the decorative pattern is formed by the combination of the printed décor and the first decorative layer for example by the uniform color thereof, so that an even larger variety of décor is made available. Furthermore, in case of damage of the second decorative layer caused by machining or wear, the presence of the first decorative layer below ensures that the color thereof is visible in order to hide the damage and indirectly increase the wear resistance of the material.

In the most preferred embodiment, the second decorative layer can comprise a foil, for example a paper foil, for example made of alfa cellulose paper. Paper is a material that is more suitable for being printed than other material like thermoplastic foil. Moreover, because of its intrinsic permeability it can be impregnated or coated to further improve printability or for being impregnated with substances that can provide a good adhesion with other layers of the decorative panel, even in case these layers are made of thermoplastic materials. In the preferred example said paper foil forming the second decorative foil, is translucent or transparent. For example, the second decorative layer can be an overlay paper. As known to the skilled person, an overlay paper is a paper used in the lamination industry for forming a transparent wear layer above a decorative pattern. An overlay paper is a paper having a relatively high impregnation capacity and a relatively low grammage, which is normally at least partially translucent and that can become transparent after impregnation with a resin. The translucency and/or transparency of the second decorative layer makes the first decorative layer visible through the second decorative layer so that the decorative pattern can be formed by the combination of the first and second decorative layer, thereby enlarging the variability of the available décors.

It is noted that the solution of forming a top layer having a second decorative layer in form of a printed paper foil provides is particularly advantageous also because the paper foil of the invention can be used in combination with other layers of the top layer being impregnated with melamine resin, as well as with other layers of the top layer being in form of thermoplastic foils, like PVC foil. In this way, with one printer it is possible to feed different decorative panel manufacturing lines like, for example, a short cycle press, a CPL, an HPL and a LVT manufacturing line. Moreover also the storage management of the decorative paper rolls can be simplified.

Preferably said foil of the second decorative layer may comprise a weight between 15 and 60 g/m2, preferably between 20 to 45 g/m2 and/or a thickness between 10 and 50 microns, preferably between 20 and 40 microns. Said relatively low grammage and thickness, which are not common for printable substrate like paper for inkjet printing, may provide for a good translucency or transparency of the paper itself. Moreover, thanks to said low thickness of the foil, it can be easier to let the ink penetrate in depth into the foil, possibly up to the entire thickness, to improve the wear resistance of the decorative panel. Preferably, said paper foil of the second decorative layer can show a mean air resistance, expressed in Gurley value (for example determined according to ISO 5636-5), below 20 seconds, preferably below 10 seconds. Said mean air resistance value can correspond to a good impregnability of the foil thereof and, consequently to a good adhesion of the paper foil to other layers of the decorative panel.

In one possible embodiment of the invention, the second decorative paper can comprise the printed décor on only one surface of the foil of the second decorative layer. This solution has the advantage of being achievable via conventional inkjet printing technologies. Nevertheless, according to a preferred embodiment of the invention, the foil of the second decorative layer can comprise a printed décor on both its surfaces. Preferably said printed décor on the surface can be the same, but specular. In this way, if the printed décor on a surface gets worn out, the one on the opposite surface remains visible so that the wear resistance of the decorative panel is improved. In some embodiments, the ink forming the unique printed décor, or both the printed decors on opposite surfaces of the foil, can penetrate into the thickness of the foil so that the foil itself is partially or entirely bulk colored by said ink so that the wear resistance of the decorative panel is ultimately improved. For example, the foil of the second decorative layer can be printed using recto-verso printing technique. In some embodiment, a recto-verso printing technique may allow for the contemporary printing on both side of a foil. For example, a recto-verso printing technique can comprise two sets of printing head facing one toward the other with the printable foil running in between the two sets of printheads so that each of them is adapted to print on a respective surface of the foil.

In one preferred embodiment the second decorative layer can comprise hard particles. Thanks to the presence of said hard particles, especially in combination with the first decorative layer below, the wear resistance of the decorative panel is increased, and the wear layer above it may be superfluous, or the wear layer can be thinner. The wear layer thickness reduction or even the absence of the wear layer itself can lead to a higher transparency of the top layer of the decorative panel thereby improving the aesthetic appearance thereof and simplifying the production process. In fact, the presence of a wear layer, especially if relatively thick, can cause a color variation on the product, meaning that the final visual color of the decorative pattern doesn't necessarily correspond to the printed décor. This inevitably leads to taking in consideration the presence of the wear layer and or the characteristic thereof when printing the printing décor. For the context of the invention, hard particles are inorganic particles showing a Mohs hardness of 7 or above. For example, hard particles can comprise one or more of those included in the following non exhaustive list: aluminum oxide, silicon oxide, zirconium oxide, carbides (for example silicon carbide), nitrides (for example silicon nitrides), artificial diamonds.

Said hard particles of second decorative coating, especially when they are provided in the foil thereof, can comprise an average particle size between 5 and 60 microns. Such a relatively small particle size limits the impact of the particles on the appearance of the decorative pattern.

Said hard particles can be present in the second decorative layer, for example in the foil thereof, in an amount between 5 and 30 g/m2.

The foil of the second decorative layer can comprise an ink receiver coating which may have the scope or preventing bleeding of the ink and improving the printability of the foil. The ink receiver coating can be provided either on one or on both the surfaces of the panel. Said ink receiver coating can be or be provided in a predetermined amount between 0.5 g/m² and 5 g/m² dry weight. The ink receiver coating can be in form of a single layer or of multiple layers, in case of multiple layers they may show a different composition. The ink receiver coating can comprise one or more of the following component: binder, flocculant and pigment.

In the preferred embodiment for the binder at least or mainly polyvinyl alcohols are used. According to variants, the ink receiver coating includes, as a binder, a polymer selected from the group consisting of hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulfate; vinylalcohol copolymers; polyvinyl acetate; polyvinyl acetal; polyvinyl pyrrolidone; polyacrylamide; acrylamide/acrylic acid copolymer; polystyrene, styrene copolymers; acrylic or methacrylic polymers; styrene/acrylic copolymers; ethylene-vinylacetate copolymer; vinyl-methyl ether/maleic acid copolymer; poly(2-acrylamido-2-methyl propane sulfonic acid); poly(diethylene triamine-co-adipic acid); polyvinyl pyridine; polyvinyl imidazole; polyethylene imine epichlorohydrin modified; polyethylene imine ethoxylated; ether bond-containing polymers such as polyethylene oxide (PEO), polypropylene oxide (PPO), polyethylene glycol (PEG) and polyvinyl ether (PVE); polyurethane; melamine resins; gelatin; carrageenan; dextran; gum arabic; casein; pectin; albumin; chitins; chitosans; starch; collagen derivatives; collodion and agar-agar. The most preferred variants for the binder are polyvinyl acetates, ethylvinylacetates, block copolymers based on polyvinylacetate, block copolymers based on polyvinylalcohol, acrylates, latexes, polyvinyl derivaties, VCVAC derivatives, polyurethanes based on polyols and isocyanates, polyurethanes based on polycarbamates and polyaldehydes, e.g. both as a watery dispersion/emulsion or a watery or solvent solution. As stated above preferred binders for the inkjet receiving coating include polyvinyl alcohol (PVA), but according to variants a vinylalcohol copolymer or modified polyvinyl alcohol may be applied. The modified polyvinyl alcohol may be a cationic type polyvinyl alcohol, such as the cationic polyvinyl alcohol grades from Kuraray, such as POVAL C506, POVAL C118 from Nippon Goshei. Preferably, said paper is provided with 0.2 to 10 g/m², and preferably between 0.5 and 5 g/m², dry coating weight of a binder in said ink receiver coating.

In case said ink receiver coating comprises a pigment, this is preferably present in an amount of 0.2 to 10 g/m², and preferably between 0.5 and 5 g/m² dry weight. Preferably said pigment has a BET surface area between 10 and 1600 m²/g, and preferably between 15 and 500 m²/g. According to the most preferred embodiment, for the pigment of said ink receiver coating at least or mainly silica particles are used. According to variants, for the pigment of said ink receiver coating at least or mainly particles are used chosen from the list consisting of calcium carbonate, alumina, aluminosilicates, ordered mesoporous materials, modified silica, organosilica, modified organosilica, organoalumina, modified alumina, aluminates, modified aluminates, organoaluminates, modified organoaluminates, zeolites, metal organic frameworks and porous polar polymers. According to some deviant embodiments, the ink receiver coating can also be pigment free.

The ink receiver coating can also comprise a flocculant, preferably a metal salt, preferably a cationic metal salt. Preferably said metal salt is chosen from the list consisting of CaCl2, MgCl2, CaBr2, MgBr2, CMA (Calcium Magnesium Acetate), NH4Cl, Calcium Acetate, ZrCl4, calcium nitrate and Magnesium Acetate. The positive ion of the dissolved metal salt will tend to neutralize the electrosteric stabilization function of the pigment contained in the ink thereby improving its absorption. The most preferred cationic metal salts are CaCl2, MgCl2, CMA, Calcium Acetate, calcium nitrate and Magnesium Acetate, as the inventors have obtained the best results with these ink reactive compounds. Said flocculant can also be chosen from the list consisting of sodiumaluminate, a double sulphate salt such as alum, polyaluminumchloride, polyacrylate, dicyandiamide (e.g. Floquat DI5 from SNF) and polyacrylamide. The flocculating agent pulls the ink pigments out of the ink dispersion. Thereby the pigments are prevented from penetration to far down into the ink receiver layer. Mainly the vehicle of the ink, e.g. the water in the case of water-based inks, is absorbed deeper down into the ink receiver layer. Preferably, the ink receiver coating is provided with 20 to 60%, based on dry coating weight of flocculating agent, in particular of metal salt.

The ink receiver coating can also comprise other components like: crosslinking agents, dispersant, coupling agent, pH modifiers, wetting agents, defoaming agents, fungicides.

In some embodiment, the ink receiver coating can comprise the hard particles described above to increase the wear resistance of the second decorative layer. Said hard particles can have the same characteristic and being provided in the same quantity as those described above. Nevertheless, it is preferred that hard particle comprised in the ink receiver coating can show an average particle size between 0.2 and 15 microns. Such a very small particle size can have a limited impact on the ink receiver coating performances, thereby allowing for a good printability.

The printed décor of the second decorative layer is preferably formed by pigmented inks, which are more resistant against UV radiation than dye-based inks. Said pigments are preferably organics as provide for a larger gamut compared to inorganic pigments. The inks are preferably provided in form of water-based inks as these produce less VOC's and show a higher compatibility with the thermal lamination procedures thereby providing decorative panels with reduced delamination issues. Preferably, said pigment is present in the second decorative layer in dry weight amount below 15, more preferably below 10 g/m2, in order to provide a good impregnability of the foil. Anyway, in certain embodiments, dye-based inks can be used as they can lead to a deeper penetration in the foil thereby providing a higher wear resistance.

In the preferred embodiment, the second decorative layer is present in the decorative panel in form of an impregnated foil, i.e. in form of a foil impregnated with a resin, preferably a thermosetting resin. Although, it is noted that in the preferred embodiment, as it will be explained below, the foil can be provided in form of a non-impregnated sheet and being impregnated during the lamination procedure, in particular by absorbing resin from other layers of the decorative panel. Said resin can comprise: aminoplast resins (for example urea formaldehyde, melamine formaldehyde, phenol formaldehyde), acrylic resin, polyurethane dispersion, vinyl chloride vinyl acetate copolymers (VC-VAC), starch or combination thereof. It is noted that acrylic resin and polyurethane dispersion can be considered adhesion promoter resin and can be used to improve the adhesion of the second decorative layer with other layers of the decorative panel that are made of thermoplastic materials like, in particular, PVC. It is not excluded that said adhesion promoter resin can, in addition or only, be provided in form of a coating on the surfaces of the second decorative layer. In case the second decorative foil is provided with said resin prior to being consolidated in the decorative panel, it is preferred that the resin in present in the foil in an amount between 45 and 125 g/m2, for example 80 g/m2 . Inventors have found that such amount can provide for a high peel strength of the top layer. In some embodiments the residual moisture content of the impregnated second decorative foil is below 10%, preferable below 8%, even more preferable below 6% (measured in a hot air oven 160 ° C.—5 minutes).

The first decorative layer can comprise a foil. Said foil can be printed using digital printing or analog printing, for example rotogravure printing. In some embodiments, the foil can be a bulk-colored foil, so that a colorant, for example a pigment, can be added in the mass of the foil to provide the desired uniform coloration of the first decorative layer. This solution ensures that in case of damages or wear of the first and/or of the second decorative layer at least said uniform color is always visible and the damage is hidden.

In a first preferred embodiment of the invention, said foil of the first decorative layer is made of paper, for example is a décor paper foil. Said décor paper can comprise a weight that is higher than the weight of the foil of the second decorative layer. For example, said weight can be higher than 20 g/m2 , preferably between 50 to 100 g/m2, e.g. between 60 and 80 g/m2. The paper layer can show a mean air resistance as expressed in Gurley value below 40 sec, preferably below 25 sec. Paper showings said mean air resistance are more prone to impregnation with resins.

Preferably according to this first preferred embodiment, the paper foil of the first decorative layer can be impregnated with a thermosetting resin, preferably a melamine formaldehyde resin, a urea formaldehyde resin, a phenol formaldehyde resin or a combination thereof.

In a second preferred embodiment of the invention, said foil is made of a thermoplastic material, for example Polyvinylchloride (PVC), Polyethylene (PE), Polyethylene terephthalate (PET), Polypropylene (PP).

The optional wear layer is preferably in form of a transparent foil and can comprise hard particles having one or more of the features described above for the second decorative layer.

In a first preferred embodiment the wear layer comprises a paper foil. Said paper foil of the wear layer can be an overlay paper. Preferably said paper foil of the wear layer may comprise a weight between 15 and 60 g/m2, preferably between 20 to 45 g/m2 and/or a thickness between 10 and 50 microns, preferably between 20 and 40 microns. Preferably, said paper foil of the wear layer can show a mean air resistance, expressed in Gurley value (for example determined according to ISO 5636-5), below 20 seconds, preferably below 10 seconds. As it is noted, it may be preferable that the foil forming the wear layer comprises one or more features in common with the paper foil of the second decorative layer.

Preferably according to this first preferred embodiment, the paper foil of the wear layer can be impregnated with a thermosetting resin, preferably a melamine formaldehyde resin, a urea formaldehyde resin, a phenol formaldehyde resin or a combination thereof. Alternatively, the paper foil of the wear layer can be impregnated with polyurethane or acrylic resin.

In a second preferred embodiment of the invention, said foil of the wear layer is made of a thermoplastic material, for example Polyvinylchloride (PVC), Polyethylene (PE), Polyethylene terephthalate (PET), Polypropylene (PP). preferably, said thermoplastic foil comprises a thickness below 300 microns, preferably below 200 microns. Such a low thickness for the wear layer provides an improved transparency which is beneficial for the aesthetic appearance of the decorative panel. Such a low thickness, moreover, can provide good wear resistance especially when the wear layer is used in combination with a second decorative layer having hard particles.

The substrate of the decorative panel can comprise a board made of a polymeric material, preferably a thermoplastic material like PP, PVC, or of a wood-based material, like HDF or MDF. Alternative materials for the substrate can be mineral based board. According to alternative embodiments, the substrate can be formed by a stack of paper foils, for example kraft paper, impregnated with a thermosetting resin, preferably phenol formaldehyde resin.

For example, the panel can be a HPL, CPL, compact, SPC or LVT panel.

It is noted that in other embodiment, the invention can also relate to general decorative element having a non-planar shape.

It is also noted that a second aspect of the invention can relate to a decorative foil having one or more of the features described above in relation to the second decorative layer, independent from the fact that it is used in a decorative panel having the feature described above and independent in particular from the presence of the first decorative layer.

Moreover it is noted that the invention, according to its third independent aspect relates to a method for manufacturing a decorative panel, preferably having one or more of the features described in combination to the independent aspect, comprising the steps of: providing a substrate; providing a first decorative foil having a substantially uniform color on the substrate; providing a second decorative foil having a printed décor on the first decorative foil; optionally, providing a wear layer above the second decorative foil; applying heat and/or pressure to consolidate the panel. In this way, a method is provided that ensures a wide variety of décor, thanks to the combination of the first and second decorative layers. Moreover, the method provides for a high wear and damage resistance of the panel. It is noted that in an alternative embodiment of the invention only the first and second decorative layer, possibly together with the optional wear layer, are consolidated via heat and pressure to form a top layer. In this case, the top layer can be fixed on the substrate via other means like, for example, via gluing.

In a preferred embodiment, the second decorative foil is provided in form of a non-impregnated foil. For example, said second decorative foil can be non-impregnated up to the moment of applying heat and pressure to consolidate the panel when, by virtue of the pressure, it receives resin from other layers of the panel, in particular from the first decorative layer and, optionally, the wear layer. This is especially the case when the first decorative layer and/or the wear layer are in the form of a paper foil.

In an alternative embodiment, especially when the first decorative layer and/or the wear layer are in the form of thermoplastic foil, the second decorative foil is impregnated and/or coated with an adhesion promoting substance. For example, said adhesion promoter substance is selected from the group comprising: polyurethane dispersion, acrylic dispersion, vinyl chloride vinyl acetate copolymers (VC-VAC), starch and/or starch or combinations thereof

The panel can be consolidated in a thermal lamination process, especially in case the when the first decorative layer and/or the wear layer are in the form of thermoplastic foil, and/or in case the substrate is made of thermoplastic material. Alternatively, especially when the substrate is made of a wood-based material and or of a stack of paper foils, the panel is consolidated in a multi-daylight press, short cycle press, continuous belt press. For example, the panel is consolidated in an HPL or CPL process.

It is noted that a fourth independent aspect of the invention can relate to a method for manufacturing a decorative foil for a decorative panel, for example a foil according to the second aspect of the invention. In particular according to said fourth independent aspect the invention can relate to a method for manufacturing a decorative foil for decorative panel that comprises the steps of:—providing a paper foil, —providing a printed décor on at least one surface of said paper foil, wherein said printed décor is provided via inkjet printing. The paper foil of this fourth embodiment, can have one or more of the following characteristics:
is an overlay paper;
comprises a mean air resistance, expressed in Gurley value, below 20 seconds, preferably below 10 seconds;
comprises a weight between 15 and 60 g/m², preferably between 20 to 45 g/m²;
comprises a thickness between 10 and 50 microns, preferably between 20 and 40 microns;
being transparent or translucent;
comprises hard particles, preferably having an average particle size between 5 and 60 microns, and/or being selected from the group comprising: aluminum oxides, silicon carbide, synthetic diamond, or other inorganic compounds having a Mohs hardness above 7, and or being present int the paper foil in an amount between 5 and 30 g/m²;
comprises an ink receiver layer, preferably comprising a binder, a pigment and/or a cationic salt,
comprises an ink receiver layer having hard particles preferably having an average particle size between 0,2 and 15 microns, and/or being selected from the group comprising: aluminum oxides, silicon carbide, synthetic diamond, or other inorganic compounds having a Mohs hardness equal or above 7, more preferably equal or above 8, and or being present int the paper foil in an amount between 5 and 30 g/m².

It is noted that the paper foil can comprise one or more of the features described above for the second decorative layer of the first independent aspect.

Preferably, the method of the fourth independent aspect comprises providing a printed décor on both the surfaces of said paper foil. Preferably, said two printed décors are specular each other. Preferably said two printed décors are printed contemporarily on the opposite surfaces of the paper foil.

Preferably the printing operation is performed using water-based inks, possibly pigment containing inks as described in relation to the first independent aspect. Preferably said operation is a single pass and/or a roll-to-roll printing operation.

In some embodiments, the paper foil can be smoothened on one or on both the surfaces to improve image quality, for example using a calender rolls. Preferably, said calendering can be performed during paper production or before printing. Smoothening is particularly of interest in case the paper foil is an overlay paper.

### BRIEF DESCRIPTION OF THE DRAWINGS

With the intention of better showing the characteristics of the invention, in the following, as an example without any limitative character, several preferred forms of embodiments are described with reference to the accompanying drawings, wherein:

FIG. 1 shows a perspective view of a decorative panel according to a first embodiment of the invention;

FIG. 2, on an enlarged view, shows the cross section along plane II-II of FIG. 1;

FIG. 3, on an enlarged view, shows the area F3 of FIG. 2;

FIG. 4 shows some steps of a method for manufacturing the decorative panel of FIG. 1;

FIG. 5 shows a perspective view of a decorative panel according to a second embodiment of the invention;

FIG. 6, on an enlarged view, shows the cross section along plane VI-VI of FIG. 5;

FIG. 7, on an enlarged view, shows the area F7 of FIG. 6;

FIG. 8 on an enlarged view, shows the area F7 of FIG. 6 according to a variant of the second embodiment of FIG. 5; and

FIG. 9 shows some steps of a method for manufacturing a decorative foil to be used in the decorative panels of FIG. 1 or 5.

### DESCRIPTION OF NON-LIMITING EMBODIMENTS

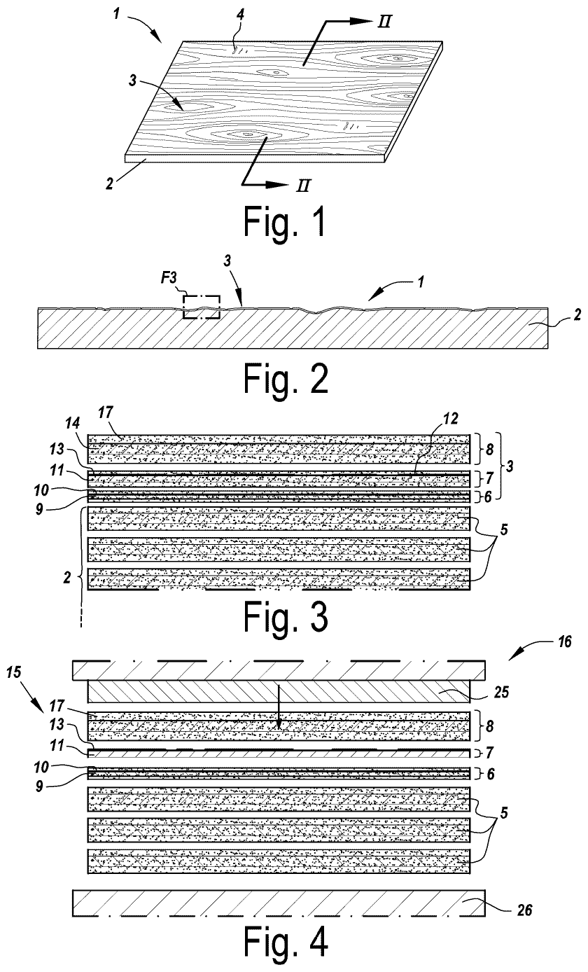

FIG. 1 shows a decorative panel 1 having a substrate 2 and a top layer 3. The top layer 3 has a decorative pattern 4 that, in the present case, represents a wood décor. The decorative panel 1 of the example is a CPL (continuous pressed laminate) for furniture cladding.

As shown in FIGS. 2 and 3 the substrate 2 is formed by a stack of kraft paper foils 5 impregnated with a phenol formaldehyde resin consolidated under application of heat and pressure.

The top layer 3 comprises, from bottom to top, a first decorative layer 6, a second decorative layer 7 and a wear layer 8 which, in this case represents the uppermost layer of the decorative panel 1.

The first decorative layer 6 comprises a first paper foil 9 having a first print layer 10 on its upper surface. The first print layer 10 is a uniform color, for example a brown color and is printed using rotogravure printing. The first paper foil 9 is a décor paper foil for rotogravure printing that has a weight comprised between 60 and 80 g/m2 and a mean air resistance, as expressed in Gurley value, below 25 sec. Said first paper foil is impregnated with a melamine formaldehyde resin. Alternatively, the first decorative layer 6 comprises a paper foil which is colored in bulk, for example with pigments dispersed in the mass of the foil.

The second decorative layer 7 comprises a second paper foil 11 having an inkjet receiver coating 12 and a printed décor 13 on its upper surface.

The second paper foil 12 is an at least partially transparent overlay paper foil that has a base paper weight comprised between 35 and 60 g/m2 a mean air resistance, as expressed in Gurley value, below 10 sec, for example 3 seconds. The second paper foil has a thickness between 20 and 40 microns, for example 30 microns.

The inkjet receiver coating 12 is present in a dry weight amount of 2 g/m2, and comprises a binder in form of a polyvinyl alcohol in a dry weight amount of 1 g/m², and a flocculant in the form of a cationic metal salt, preferably CaCl2 in a dry weight amount of 1 g/m².

The printed décor 13 is inkjet printed and formed by organic pigment. In particular the printed décor 13 is obtained via jetting drops of water-based pigment containing inks. The printed décor 13, in the example, represents a pattern of wood nerves.

It is noted that the decorative pattern 4 of the decorative panel 1 is formed by the combination of the uniform color of the first print layer 10 of the first decorative layer 6, and of the printed décor 13 of the second decorative layer 7.

The wear layer 8 comprises a third paper foil 14 in form of an at least partially transparent overlay paper foil that has a base paperweight comprised between 15 and 40 g/m2 and a mean air resistance, as expressed in Gurley value, below 10 sec, for example 3 seconds. Said third paper foil 14 is impregnated with a melamine formaldehyde resin and contains hard particles of aluminum oxide.

FIG. 4 shows a step of a method for manufacturing the decorative panel 1 wherein a stack 15 is formed in a press 16 having an upper and a lower plate 26. The stack comprises 15 comprises the kraft paper foils 5 for forming the substrate 2, the already printed first paper foil 9 of the first decorative layer 6, the already printed second paper foil 11 of the second decorative layer 7 and the third paper foil 14 of the wear layer 8.

It is noted that all the foils forming the stack 15 in the press 16 are impregnated with a thermosetting resin composition 17, for example phenol formaldehyde and/or melamine formaldehyde, with the sole exception of the second paper foil 11 of the second decorative layer 7 which, in the press 16, is in a non-impregnated condition. The press 16 applies a pressure of 60 kg/cm2 and heat up to a temperature of between 150-195 ° C. to the stack 15 to harden the thermosetting resin composition 17 thereby consolidating the layers together and forming the decorative panel 1. The applied pressure causes the thermosetting resin composition 17 to impregnate the second paper foil 11 of the second decorative layer 7. This impregnation in the pressing step is facilitated on one hand by the features of the second paper foil 11, which is extremely light and permeable, and on the other hand by the fact that since the decorative pattern is formed in two layers (namely the first and the second decorative layers 6, 7) the printed décor 13 is formed by a relatively low amount of pigment so that obstacles to impregnation are avoided or at least reduced.

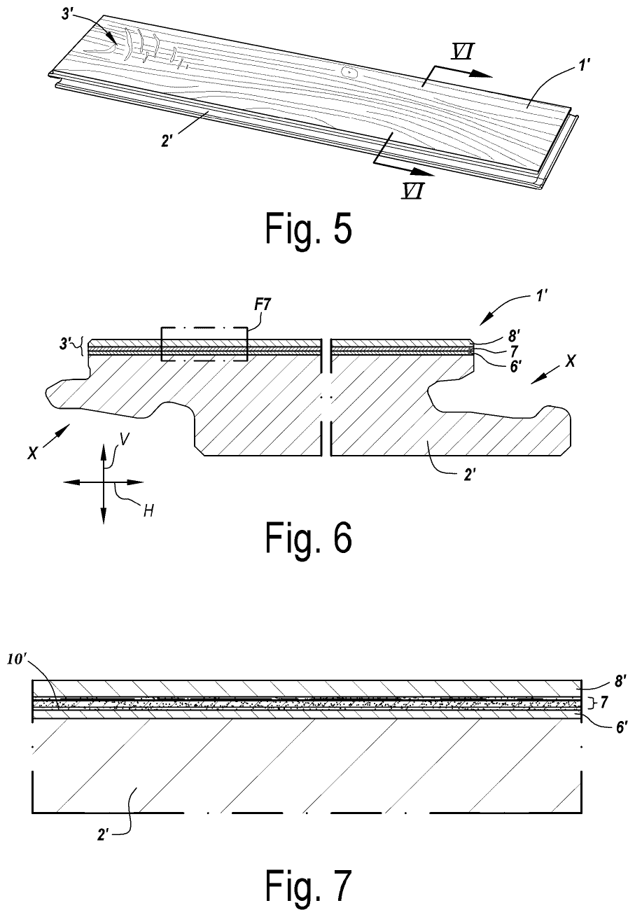

FIG. 5 shows a decorative panel 1′ having a substrate 2′ and a top layer 3′ according to a second embodiment of the invention that differs from that of FIG. 1 in that the decorative panel 1′ is an LVT floor panel.

As shown in FIGS. 6 and 7 the substrate 2′ is made of PVC. The top layer 3′ comprises a first decorative layer 6′, a second decorative layer 7 and a wear layer 8′.

The first decorative layer 6′ comprises a PVC foil printed by rotogravure to form the first printed layer 10′ of uniform color. Alternatively, the first decorative layer 6′ comprises a PVC foil which is colored in bulk, for example with pigments dispersed in the mass of the foil.

The second decorative layer 7 of FIG. 7, differs from that described for figures from 1 to 3, only in that it impregnated with a polyurethane resin in a dry weight amount of 80 g/m2.

The wear layer 8′ is in form of a transparent PVC sheet comprising a 200 microns thickness.

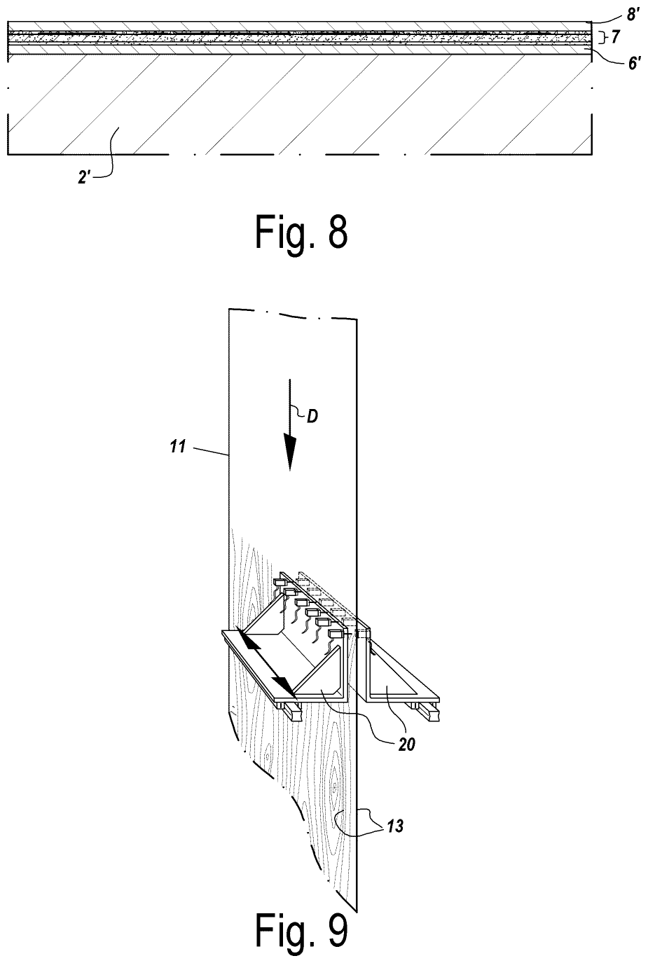

FIG. 8 shows a variant of embodiment of figures from 5 to 7, that differs only in that the second paper foil 11 comprises hard particles in the form of aluminum oxide, having an average particle dimension comprised between 10 and 80 microns, and provided together with the polyurethane resin in an amount comprised between 2 and 20% weight based on the dry weight of the polyurethane resin. This embodiment further differs in that the wear layer 8′ comprises a thickness of 100 microns.

FIG. 9 shows a step for realizing a variant of the second decorative layer 7 of the embodiments above, wherein the second paper foil 11 is provided on both its surfaces with the printed décor 13. In particular, the second paper foil 11 runs from top to bottom between two facing each other shuttles 20 of printing heads in a multi-pass printer. The second paper foil 11 thus advances in a multi-pass mode in a vertical direction D while, between one pass and the other, the shuttles 20 run in a direction perpendicular to the drawing to print a swath of the printed décors 13.

The present invention is in no way limited to the hereinabove described embodiments, but such decorative panels and method may be realized according to different variants without leaving the scope of the present invention.

Further, as is clear from the content of the description, the present invention relates to one or more of the items as listed below:
1. A decorative panel of the type comprising a substrate and a top layer, wherein the top layer comprises a decorative pattern, wherein the top layer comprises a first decorative foil having a substantially uniform color and a second decorative foil comprising a printed décor, wherein the second decorative foil overlays the first decorative foil so to form the decorative pattern.
2. The decorative panel of item 1, wherein the second decorative foil comprises a paper foil, preferably an alfa cellulose paper.
3. The decorative panel of item 2, wherein the paper foil of the second decorative foil comprises a mean air resistance, expressed in Gurley value, below 20 seconds, preferably below 10 seconds.
4. The decorative panel of item 2, wherein the paper foil of the second decorative foil comprises a weight between 15 and 60 g/m², preferably between 20 to 45 g/m² and/or a thickness between 10 and 50 microns, preferably between 20 and 40 microns.
5. The decorative panel according to any of the preceding items, wherein the second decorative foil comprises a printed pattern on both sides of the foil.
6. The decorative panel according to any of the preceding items, wherein the second decorative foil is transparent or translucent.
7. The decorative panel according to any of the preceding items, wherein the second decorative foil comprises hard particles.
8. The decorative panel according to item 7, wherein said hard particle comprise an average particle size between 5 and 60 microns, and/or are selected from the group comprising: aluminum oxides, silicon carbide, synthetic diamond, or other inorganic compounds having a Mohs hardness equal or above 7, preferably equal or above 8.
9. The decorative panel according to item 8, wherein said hard particles are present int the second decorative foil in an amount between 5 and 30 g/m².
10. The decorative panel according to any of the preceding items, wherein the second decorative foil comprises an ink receiver layer, preferably comprising a binder, a pigment and/or a cationic salt.
11. The decorative panel according to item 10, wherein said ink receiver layer is provided on both the surfaces of the second decorative foil.
12. The decorative panel according to item 10, wherein the ink receiver layer comprises hard particles.
13. The decorative panel according to item 11, wherein said hard particle comprise an average particle size between 0.2 and 15 microns, and/or are selected from the group comprising: aluminum oxides, silicon carbide, synthetic diamond, or other inorganic compounds having a Mohs hardness equal or above 7, preferably equal or above 8.
14. The decorative panel according to item 11 or 12, wherein said hard particles are present int the inkjet receiver layer in an amount between 5 and 30 g/m².
15. The decorative panel according to any of the preceding item, wherein the printed décor is formed by pigmented ink or dyed ink.
16. The decorative panel according to any of the preceding items, wherein the second decorative foil comprises an acrylic resin and/or a polyurethane dispersion, VC-VAC, starch.
17. The decorative panel according to any of the preceding items, wherein the first decorative layer comprises a paper foil or a thermoplastic foil.
18. The decorative panel according to item 16, wherein the first decorative foil in form of a paper foil is impregnated with aminoplast resin, such as melamine formaldehyde resin
19. The decorative panel according to any of the preceding items, wherein the first decorative foil is printed using rotogravure printing.
20. The decorative panel according to any of the preceding items, wherein the first decorative foil is a bulk-colored foil.
21. The decorative panel according to any of the preceding items, wherein the top layer comprises a wear layer above the second decorative foil.
22. The decorative panel according to item 20, wherein the wear layer comprises a thermoplastic foil or a melamine impregnated paper.
23. The decorative panel according to item 21, wherein said thermoplastic wear layer comprises a thickness below 300 microns, preferably below 200 microns.
24. The decorative panel according to any of the preceding items, wherein the second decorative foil is the uppermost layer of the panel.
25. The decorative panel according to any of the preceding items, wherein the substrate comprises a board made of a polymeric material, preferably a thermoplastic material like PP, PVC, or of a wood-based material, like HDF or MDF.
26. The decorative panel according to any of items from 1 to 23, wherein the substrate is formed by a stack of multiple resin impregnated kraft paper foils.
27. The decorative panel according to any of the preceding items, wherein the panel is HPL, CPL, SPC or LVT panel.
28. A method for manufacturing a decorative panel, preferably according to any of the preceding items, comprising the steps of:
providing a substrate;
providing a first decorative foil having a substantially uniform color on the substrate;
providing a second decorative foil having a printed décor on the first decorative foil;
optionally, providing a wear layer above the second decorative foil,
applying heat and/or pressure to consolidate the panel.
29. The method according to item 28, wherein the second decorative foil is a non-impregnated foil.
30. The method according to item 28, wherein the second decorative foil is impregnated and/or coated with an adhesion promoting resin.
31. The method according to item 30, wherein said adhesion promoting substance is selected from the group comprising: aminoplast resins (e.g. melamine formaldehyde and/or urea formaldehyde), polyurethane dispersion, acrylic dispersion and/or starch.
32. The method according to any of items from 27, wherein the second decorative foil is printed using recto-verso printing.
33. A method for manufacturing a decorative foil for decorative panel that comprises the steps of:
   providing a paper foil,
   providing a printed décor on at least one surface of said paper foil, wherein said printed décor is provided via inkjet printing;
wherein the paper foil of this fourth embodiment, can have one or more of the following characteristics:
   is an overlay paper;
   comprises a mean air resistance, expressed in Gurley value, below 20 seconds, preferably below 10 seconds;
   comprises a weight between 15 and 60g/m², preferably between 20 to 45 g/m²;
   comprises a thickness between 10 and 50 microns, preferably between 20 and 40 microns;
   being transparent or translucent;
   comprises hard particles, preferably having an average particle size between 5 and 60 microns, and/or being selected from the group comprising: aluminum oxides, silicon carbide, synthetic diamond, or other inorganic compounds having a Mohs hardness equal or above 7 (preferably equal or above 8), and/or being present int the paper foil in an amount between 5 and 30 g/m²;
   comprises an ink receiver layer, preferably comprising a binder, a pigment and/or a cationic salt,
   comprises an ink receiver layer having hard particles preferably having an average particle size between 0,2 and 15 microns, and/or being selected from the group comprising: aluminum oxides, silicon carbide, synthetic diamond, or other inorganic compounds having a Mohs hardness equal or above 7 (preferably equal or above 8), and/or being present int the paper foil in an amount between 5 and 30 g/m².
34. The method according to item 33, wherein printing comprises providing a printed décor on both the surfaces of said paper foil, preferably, said two printed décors are specular each other, more preferably said two printed décors are printed contemporarily on the opposite surfaces of the paper foil.
35. The method according to item 33 or 34, wherein the printing operation is performed using water-based inks, possibly pigment containing inks.
36. The method according to any item from 33 to 35, wherein said operation is a single pass and/or a roll-to-roll printing operation.
37. A decorative foil that:
   is obtainable through the method according to any of items from 33 to 37, or
   that comprises a printed décor (preferably via inkjet printing) and comprises one or more of the following characteristics:
   is an overlay paper;
   comprises a mean air resistance, expressed in Gurley value, below 20 seconds, preferably below 10 seconds;
   comprises a weight between 15 and 60 g/m², preferably between 20 to 45 g/m²;
   comprise a thickness between 10 and 50 microns, preferably between 20 and 40 microns;
   being transparent or translucent;
   comprises hard particles, preferably having an average particle size between 5 and 60 microns, and/or being selected from the group comprising: aluminum oxides, silicon carbide, synthetic diamond, or other inorganic compounds having a Mohs hardness equal or above 7 (preferably equal or above 8), and/or being present int the paper foil in an amount between 5 and 30 g/m²;
   comprises an ink receiver layer, preferably comprising a binder, a pigment and/or a cationic salt,
   comprises an ink receiver layer having hard particles preferably having an average particle size between 0,2 and 15 microns, and/or being selected from the group comprising: aluminum oxides, silicon carbide, synthetic diamond, or other inorganic compounds having a Mohs hardness equal or above 7 (preferably equal or above 8), and/or being present int the paper foil in an amount between 5 and 30 g/m².

1. A decorative panel comprising:
a substrate; and
a top layer provided on the substrate;
wherein the top layer includes a decorative pattern;
wherein the top layer includes
a first decorative foil having a uniform color, and
a second decorative foil having a printed décor;
wherein the second decorative foil overlays the first decorative foil to form the decorative pattern.

2. The decorative panel of claim 1, wherein the second decorative foil comprises a paper foil.

3. The decorative panel of claim 2, wherein the paper foil of the second decorative foil has a mean air resistance, expressed in Gurley value, below 20 seconds.

4. The decorative panel of claim 2, wherein the paper foil of the second decorative foil has a base paper weight between 15 and 60 g/m2 and/or a thickness between 10 and 50 microns.

5. The decorative panel according to claim 1, wherein the second decorative foil has a printed pattern on both sides of the foil.

6. The decorative panel according to claim 1, wherein the second decorative foil is transparent or translucent.

7. The decorative panel according to claim 1, wherein the second decorative foil comprises hard particles.

8. The decorative panel according to claim 7, wherein the hard particles have an average particle size between 5 and 60 microns, and/or are selected from the group consisting of: aluminum oxides, silicon carbide, synthetic diamond, or other inorganic compounds having a Mohs hardness equal to or above 7.

9. The decorative panel according to claim 8, wherein the hard particles are present in the second decorative foil in an amount between 5 and 30 g/m2.

10. The decorative panel according to claim 1, wherein the second decorative foil comprises an ink receiver layer.

11. The decorative panel according to claim 10, wherein the ink receiver layer is provided on both surfaces of the second decorative foil.

12. The decorative panel according to claim 10, wherein the ink receiver layer comprises hard particles.

13. The decorative panel according to claim 12, wherein the hard particles have an average particle size between 0.2 and 15 microns, and/or are selected from the group consisting of: aluminum oxides, silicon carbide, synthetic diamond, or other inorganic compounds having a Mohs hardness equal to or above 7.

14. The decorative panel according to claim 12, wherein the hard particles are present int the inkjet receiver layer in an amount between 5 and 30 g/m2.

15. The decorative panel according to claim 1, wherein the printed décor is formed by pigmented ink or dyed ink.

16. The decorative panel according to claim 1, wherein the second decorative foil comprises an acrylic resin a polyurethane dispersion, VC-VAC, and/or starch.

17. The decorative panel according to claim 16, wherein the first decorative foil is in form of a paper foil, and is impregnated with aminoplast resin.

18. The decorative panel according to claim 1, wherein the first decorative foil is printed using rotogravure printing.

19. The decorative panel according to claim 1, wherein the first decorative foil is a bulk-colored foil.

20. The decorative panel according to claim 1, wherein the top layer comprises a wear layer above the second decorative foil.
